(19) United States
(12) Patent Application Publication
(10) Pub. No.: US 2005/0109475 A1
(43) Pub. Date: May 26, 2005

(54) Method for ozone treatment of a liquid phase containing solid particles

(76) Inventor: Alain Trichet, Montellier (FR)

Correspondence Address: Air Liquide;Intellectual Property Department, Suite 1800, 2700 Post Oak Boulevard, Houston, TX, 77056, US

(21) Appl. No.: 10/504,807

(22) PCT Filed: Feb. 12, 2003
(86) PCT No.: PCT/FR03/00462

(30) Foreign Application Priority Data
Feb. 18, 2002 (FR) 02/02023

(51) Int. Cl. F02M 69/02; D21C 9/147

(52) U.S. Cl. 162/65; 261/34.1; 162/83

(57) ABSTRACT

The invention concerns a novel method for ozone treatment 1 of a liquid phase containing solid particles, in particular paper pulp. Said method is characterized in that the liquid phase (3), containing 0.5 to 5 wt. % of solid, and the gas containing ozone are introduced in cocurrent into a tubular reactor (T).

The invention relates to a method for ozonizing a liquid phase containing solid particles. It relates more particularly to a method for ozonizing paper pulps.

Ozone is increasingly used in the treatment of paper pulps, both virgin pulps and pulps produced with waste paper for recycling.

In fact, ozonizing steps are injected into methods for manufacturing virgin paper pulps, in particular for bleaching these paper pulps.

Ozonization steps are also put into practice in methods for treating waste papers for their recycling, their bleaching, their defluorescence, their deinking, and the removal of the microorganisms and enzymes carried by the waste papers.

Paper pulps, both virgin pulps and pulps from papers to be recycled, can be considered as a liquid phase containing solid particles, the solid particles being the disintegrated paper.

A paper pulp ozonizing method is known in which the paper pulp is ozonized when it has a solids concentration between about 25 to 40% by weight of the total weight of the pulp.

In this method, towers are used, into which the pulp falls, or systems of the feed screw type. In this method, it is necessary to previously concentrate the pulp on filter presses to obtain the right concentration, which can embrittle the paper fibers. Moreover, these filter presses are costly.

Furthermore, owing to the high reactivity of ozone, risks of heterogeneous treatments exist at these high solids concentrations.

A paper pulp ozonizing method is also known in which a paper pulp is used having a solids concentration of about 8 to 12% by weight of the total weight of the pulp.

In this method, mixers are used, known in the papermaking profession by the name “dynamic mixer”, which are centrifugal pumps in practice. The reaction occurs here under pressure and the residence time is about a few seconds. Here also, the paper fiber is subjected to high mechanical stresses which can damage it.

Moreover, since the reaction takes place under pressure, it is necessary to compress the ozone in this method. The compressors are costly to buy and require considerable maintenance.

Ozone is also used in numerous other branches of industry to ozonize solids present in a liquid phase. The same problems are encountered in this case.

It is an object of the invention to overcome the drawbacks of the ozonizing methods of the prior art by proposing a method for ozonizing a pulp that can be considered as a liquid phase containing solid particles, which serves to limit the mechanical stresses applied to the pulp, to obtain a uniform ozonization of the pulp, and to reduce and indeed eliminate the ozone compression step.

For this purpose, the invention proposes a method for ozonizing a liquid phase containing solid particles by contact with gaseous ozone, characterized in that it is put into practice in a two-phase tubular contactor of the gas-liquid type operating with liquid and gas flowing cocurrently, and in that the liquid phase containing solid particles is injected into the contactor at a solids concentration between 0.5 and 5% by weight of the total weight of the liquid phase containing solid particles.

Preferably, the liquid phase containing solid particles is injected into the contactor at a solids concentration between 0.5 and 3% by weight of the total weight of the liquid phase containing solid particles.

Advantageously, the ozone is injected into the contactor in the form of an air-ozone or oxygen-ozone gas mixture.

Preferably, the ozone is injected into the contactor in the form of a gas mixture containing 50 to 200 g of ozone per m³ of gas mixture.

In all cases, the ozone or the gas mixture is preferably injected into the contactor at a speed of above 0.5 m/s and not more than 10 m/s.

In a preferred embodiment, the contactor is put into practice in wave regime.

In another-preferred embodiment, the contactor is put into practice in plug regime.

Thus, preferably, the ozone or the gas mixture is injected into the contactor at a speed of between 0.5 and 2 m/s and the liquid phase containing solid particles is injected into the contactor at a speed of between 0.5 and 2 m/s.

In a particularly preferred embodiment, the tubular contactor is a horizontal stainless steel tubular contactor having an inside diameter and a length making it possible, in view of the pulp flow rate, to obtain injection speeds of the liquid phase and of the ozone or of the gas mixture of between 0.5 and 2 m/s.

The method according to the invention is particularly suitable when the liquid phase containing solid particles is a paper pulp.

The invention will be better understood and other aims, features and advantages of the invention will appear more clearly from a reading of the explanatory description that follows, with reference to the figures appended hereto, in which:

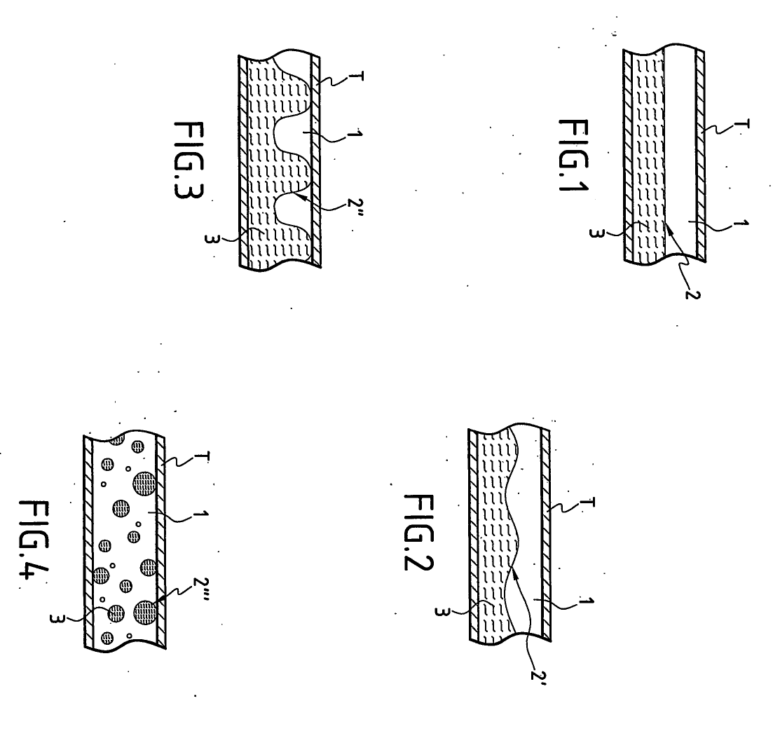

FIG. 1 is a schematic cross-sectional view of a two-phase tubular contactor of the gas-liquid type operating in segregated regime,

FIG. 2 is a schematic cross-sectional view of a two-phase tubular contactor of the gas-liquid type operating in wave regime,

FIG. 3 is a schematic cross-sectional view of a two-phase-tubular contactor of the gas-liquid type operating in plug regime, and

FIG. 4 is a schematic cross-sectional view of a two-phase tubular contactor of the gas-liquid type operating in dispersed bubble regime.

The high reactivity of ozone enables it to react rapidly with most of the major functions of organic chemistry, and in particular with all unsaturated benzene or phenolic groups often present, particularly in waste paper.

Moreover, ozone destroys the microorganisms such as bacteria, fungi, yeasts, as well as enzymes such as catalase enzyme often present, particularly in waste paper.

Ozone therefore finds a particular application in the manufacture of paper pulps, whether virgin pulps or pulps produced with waste paper for recycling.

Thus, ozone can be used in numerous methods for manufacturing paper pulps to bleach the pulps, eliminate the dyes, the optical brightneners, the glues and the inks, and also to clean up the circuits of the installations in which the manufacturing methods are put into practice.

However, at the present time, ozonization methods, particularly for paper pulps, whether the pulps are virgin pulps or produced from waste paper, take place at a solids concentration between 8 and 40 g of solids per 100 g of pulp.

Since the paper pulps can be considered as a liquid medium, generally an aqueous medium, in which solid particles, particularly wood fibers, are in suspension, during the ozonization reaction, the situation is one of a mixture which can be considered as a two-phase mixture: a gas phase and a liquid phase containing solid particles. Since the chemical reaction of solids ozonization is rapid, it is necessary to have a very fast gas dissolution rate in said liquid phase containing solid particles for the ozone to react rapidly with all the solid particles and so that the reaction is not limited by the ozone dissolution rate.

When operating at atmospheric pressure according to the prior art, the high solids concentration of the pulp and the high reactivity of the ozone mean that the risks of heterogeneous treatments exist. Another method of the prior art accordingly proposes, to increase the ozone dissolution rate in the liquid-solid phase, to conduct the ozonization reaction under pressure, which requires compressing the ozone.

This means that the paper fiber is subjected to high mechanical stresses which can damage it; moreover, to compress the ozone requires the use of costly compressors, in terms of both purchase and maintenance.

It has now been discovered that all these drawbacks were overcome by carrying out the ozonization method on liquids containing solid particles such as paper pulps, but having a low solids concentration, that is, paper pulps with low or very low consistencies.

In the foregoing discussion and in what follows below, the terms “low consistency paper pulp” mean a paper pulp and, by extension, a liquid-solid mixture, of which the concentration of solid particles is between 0.5 and 5% by weight of the total weight of the liquid/solid mixture. In fact, the upper concentration limit of the pulp will be determined by the transition of the pulp from a newtonian behavior to a nonnewtonian behavior; this value depends on the type of wood.

In the foregoing discussion and in what follows below, the terms “very low consistency paper pulp” mean a paper pulp and, by extension, a liquid-solid mixture of which the solid particles concentration is about 1% by weight of the total weight of the liquid-solid mixture.

In fact, for liquid phases having such solids concentrations, it is possible to use two-phase tubular gas-liquid contactors which serve to obtain very high values of the gas dissolution rate in the liquid phase containing solid particles.

The ozonizing method of the invention is therefore characterized in that it is put into practice in a two-phase tubular contactor of the gas-liquid type and in that the liquid phase containing solid particles is injected at low or very low consistency.

The tubular contactor for putting the method of the invention into practice can be a horizontal or vertical tubular contactor, or of any intermediate inclination, operating with cocurrent flow of the liquid phase containing solid particles.

The gas can be injected by a simple pipe or by a more sophisticated system, for example a static mixer.

The ozone dissolution rate in the liquid phase containing solid particles depends on the gas-liquid mass transfer coefficients, and the aim here is to obtain a good gas-pulp emulsion.

Depending on the respective injection speeds of the gas and the pulp, the reactor will operate in segregated regime, wave regime, plug regime or dispersed bubble regime.

FIG. 1 is a schematic cross section of a horizontal tubular contactor T operating in segregated regime, in which the gas phase is denoted 1 and the liquid phase containing solid particles is denoted 3. In FIG. 1, the interfacial area is shown by the contact surface between the gas phase 1 and the liquid phase 3.

This contact surface 2, when the tubular contactor is in segregated regime, as shown in FIG. 1, can be considered as a plane surface.

In this case, the interfacial area corresponding to the contact surface 2 is smaller than in the cases shown in FIGS. 2 to 4, which are discussed below. For this reason, the ozone dissolution rate is less favorable.

Such a segregated regime is obtained when the respective injection speeds of the gas phase and the liquid phase are less than 0.5 m/s.

The contact surface between the gas phase and the liquid phase containing solid particles is improved when the contactor T operates in wave regime, as shown in FIG. 2.

As FIG. 2 shows, the contact surface denoted 2′ between the gas phase 1 and the liquid phase containing solid particles 3, forms waves. The contact surface is increased in this range. The gas is therefore dissolved more rapidly in this case than in the case shown in FIG. 1, that is, in segregated regime.

The ozone dissolution rate, and hence the rate of reaction of the ozone with the solids present in the liquid phase is further improved when, as shown in FIG. 3, the tubular contactor T operates in plug regime. As FIG. 3 shows, when the tubular contactor T operates in plug regime, the liquid phase 3 is actuated with a movement that makes it touch the two inside horizontal walls of the contactor.

The gas phase 1 therefore has a high contact surface denoted 2″ with the liquid phase 3 when the contactor operates in such a plug regime.

The contactor T operates in wave regime or in plug regime when the respective injection speeds of the gas phase and the liquid phase containing solid particles are between 1 and 2 m/s.

The best results are obtained when the contactor is in dispersed bubble flow regime, as shown in FIG. 4. In this case, the liquid phase 3 forms bubbles which are dispersed in the gas phase 1 and the contact surface 2′″ between the gas phase 1 and the liquid phase containing solid particles 3 is very high.

Such a dispersed bubble regime is obtained for respective injection speeds of the gas and liquid phase containing solid particles higher than 2 m/s and up to as high as 10 m/s.

However, to obtain such a dispersed bubble operating regime, it is necessary to use very high gas pressures, and this is not preferable in the method according to the invention, because it again entails the need to use a gas compressor with the associated purchase and maintenance costs. Moreover, the drawback associated with the mechanical stresses exerted on the liquid phase, and in particular on the paper fiber, recurs here.

Thus, for the reasons set forth above, and although the ozonization method according to the invention can be put into practice in the contactor T operating in segregated regime, in wave regime, in plug regime or in dispersed bubble regime, it will be preferably put into practice in wave regime or in plug regime, that is, with gas injection speeds of between 0.5 and 2 m/s and injection speeds of the liquid phase containing solid particles of between 0.5 and 2 m/s.

The injection speeds given above and below are speeds obtained when the contactor T is empty. In other words, the gas injection rate will be calculated as a function of the internal cross section of the contactor used, in order to obtain a gas injection speed of between 0.5 and 2 m/s when the contactor does not contain liquid phase containing solid particles.

Similarly, the injection speed of the liquid phase containing solid particles will be calculated as a function of its injection rate into the empty-contactor and as a function of the internal cross section of the contactor.

To apply an adequate gas injection speed, it is advantageous to use a gas mixture containing ozone and a carrier gas such as, for example, air or oxygen, at high ozone concentrations.

Ozone is highly reactive, and the quantities of ozone necessary are generally small; by way of example, in the case of paper pulps, they are less than 20 kg/t of pulp.

Thus, it has been determined that an ozone-air gas mixture containing 50 to 200 g of ozone per m³ of gas mixture is perfectly suitable.

In order to better understand the invention, an illustrative and non-limiting example of an embodiment thereof will now be described.

### EXAMPLE

A horizontal stainless steel tubular contactor is used having an inside diameter of 4.5 cm and a length of 100 m. The contactor is supplied with a virgin paper pulp with a consistency of 2.5%.

The flow rate of the paper pulp is calculated in order to obtain pulp speeds (in the empty contactor) between 1 and 2 m/s.

The same speeds are used for the gas mixture formed of a mixture of air and ozone having an ozone content of 100 g/M³ of mixture.

Under these conditions, the pressure losses are 2 to 3 bar.

The ozone transfer capacity is accordingly 1.5 to 3 kg/t of pulp for a residence time of about one minute.

The pressure losses of 2 to 3 bar are sufficiently low to be compatible with existing ozone compression systems, and even without compressor, if the ozonator withstands a slight overpressure. The installation is hence inexpensive and easy to use.

Evidently, the invention is not at all limited to the embodiment described and illustrated, which has only been provided by way of example.

Thus, although the invention has been described with reference to a virgin paper pulp, the method according to the invention can be applied to the ozonization of all other phases which can be considered as a liquid phase containing solid particles and in particular papers to be recycled, insofar as the solids content does not exceed 5% by weight of the total weight of the pulp.

Similarly, although in the above discussion, the tubular contactor has been described as being made of stainless steel, it can be made of any other material compatible with humid ozone.

Similarly, although in the above discussion, the tubular contactor has been described as having an inside diameter of 4.5 cm and a length of 100 m, its dimensions can be different, the essential factor being that its dimensions enable the pulp to reside in the contactor for the time necessary to complete the ozonization reaction, in consideration of the pulp feed rate into the contactor.

Moreover, although the gas mixture is generally an air-ozone or oxygen-ozone mixture, any other gas or mixture of gases not reacting with ozone can be used as carrier gas.

This means that the invention comprises all the technical equivalents of the means described as well as their combinations, if these are carried out in accordance with its spirit.

1-10. (canceled)

11. A method for ozonizing comprising contacting a liquid containing solid particles with a gas mixture providing ozone, wherein:
a) said contacting is performed in a two-phase tubular contactor, wherein said contactor comprises a gas-liquid type; and
b) said liquid is injected into said contactor with a concentration of said solid particles between about 0.5% and about 5% of the total weight of said liquid.

12. The method of claim 11, wherein said concentration is between about 0.5% and about 3% of the total weight of said liquid.

13. The method of claim 11, wherein said gas mixture injected into said contactor comprises at least one member selected from the group consisting of:
a) an air-ozone mixture;
b) an oxygen-ozone mixture; and
c) a nitrogen-ozone mixture.

14. The method of claim 11, wherein said gas mixture injected into said contactor comprises at least one member selected from the group consisting of:
d) an air-oxygen mixture; and
e) an oxygen-ozone mixture.

15. The method of claim 11, wherein said gas mixture injected into said contractor comprises a mixture of ozone and at least one other gas which does not react with said ozone.

16. The method of claim 13, wherein said mixture comprises about 50 g of ozone to about 200 g of ozone per m³ of said gas mixture.

17. The method of claim of claim 11, wherein said gas mixture is injected into said contactor at a rate between about 0.5 m/s to about 10 m/s.

18. The method of claim 11, wherein said method is performed in a wave regime.

19. The method of claim 11, wherein said method is performed in a plug regime.

20. The method of claim 11, wherein said gas mixture and said liquid are each injected into said contactor at a rate between about 0.5 m/s and about 2 m/s.

21. The method of claim 20, wherein said contactor comprises a horizontal stainless steel tubular contactor.

22. The method of claim 11, wherein said liquid comprises a paper pulp.

23. A method for ozonizing comprising contacting a liquid containing solid particles with a gas mixture providing ozone, wherein:
a) said contacting is performed in a two-phase tubular contactor, wherein said contactor comprises a gas-liquid type;
b) said liquid is injected into said contactor with a concentration of said solid particles between about 0.5% and about 5% of the total weight of said liquid;
c) said gas mixture and said liquid are each injected into said contactor at a rate between about 0.5 m/s and about 2 m/s;
d) said liquid comprises a paper pulp; and
e) said gas mixture comprises at least one member selected from the group consisting of:
1) an air-ozone mixture; and
2) an oxygen-ozone mixture.
